(19) United States
(12) Patent Application Publication
(10) Pub. No.: US 2007/0201746 A1
(43) Pub. Date: Aug. 30, 2007

(54) Scene change detector algorithm in image sequence

(75) Inventor: Yong Sung Kim, Seoul (KR)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Konan Technology, Seoul (KR)

(21) Appl. No.: 10/514,526

(22) PCT Filed: May 20, 2002
(86) PCT No.: PCT/KR02/00949

§ 371 Date: May 6, 2005

(51) Int. Cl. G06K 9/46

(52) U.S. Cl. 382/190

(57) ABSTRACT

A scene change detector algorithm in image sequence is disclosed, in which a two-stage detecting process is applied to perceive a scene change in a precise and safe way. The algorithm includes classifying images into two different states, a transition state and a stationary state, after determining whether there is any change in adjacent frames, and confirming the scene change by rechecking whether there is the scene change in the classified frames.

### TECHNICAL FIELD

The present invention relates to a method for detecting a scene change from digital images, and more particularly, to a method for detecting a scene change from digital images by using two stage detection process, and a method of extracting a key frame.

### BACKGROUND ART

Recently, starting from video search by means of video indexing, a variety of multimedia service systems have been developed. In general, since the digital video has an enormous data quantity, and similar images continuous within one scene, the video can be searched effectively by indexing the video in scenes. In this instance, a technology for detecting a scene change time point, and extracting a key frame, a representative image of the scene, is essential in constructing a video indexing and searching system.

Objects of the method for detecting a scene change lie on detection of the following scene changes.

\textcircled{1} Cut: a sudden image change.

\textcircled{2} Fade: an image change while an image becomes darker or brighter.

\textcircled{3} Dissolve: an image change as two images overlap.

\textcircled{4} Wipe: an image change as if a previous image is wiped out.

Though the scene change of the cut can be detected by a simple algorithm as what is required is only detecting of a difference between frames, an accurate detection of the other scene changes is difficult because the scene change is progressive, such that the scene change is confused with a progressive change within a scene caused by movement of a person, object, or a camera.

There are the following two approaches in the method for detecting a scene change.

The first one is an approach in which a compressed video data is not decoded fully, but only a portion of information, such as motion vectors, and DCT (Discrete Cosine Transformation) are extracted for detecting the scene change. Though this approach is advantageous in that a process speed is relatively fast because the compressed video is processed without decoding the compressed video fully, this approach has the following disadvantages.

Since only a portion of the video is decoded for detecting the scene change, an accuracy of the detection is poor due to shortage of information, and the scene change detecting method becomes dependent on video compression methods which vary recently so as to require varying the detection method depending on the compression method. Moreover, since the motion vectors, the macro block types and the like, information this approach uses mainly, can differ substantially depending on an encoding algorithm, a result of the scene change detection can differ depending on encoders and encoding methods, even if video is the same.

The second approach is decoding the compressed video fully, and detecting the scene change from an image domain. Though this method has a high accuracy of scene change detection compared to the former method, this method is disadvantageous in that a process speed drops as much as a time period required for decoding the compressed video. However, enhancing the accuracy of the scene change detection is regarded more important than reducing the time period required for decoding in view that a performance of the computer has been recently improved sharply, hardware can be used in decoding the video, and an amount of calculation required for the decoding does not matter if software optimizing technologies, such as MMX 3DNow and the like, are employed.

The present invention follows the latter approach.

In the scene change detecting methods of the latter approach under research presently, there are a method of using a pixel value difference (template matching), a method of using a histogram difference, a method of using an edge difference, a method of using block matching, and the like, which will be described, briefly.

In the template matching, a difference of two pixel values having the same spatial positions between two frames is calculated, and used as a scale for detecting the scene change. In the method of using a histogram difference (histogram comparison), luminance components and color components within an image are represented with histograms, and differences of the histograms are used. In the method of using an edge difference, an edge of an object in the image is detected, and the scene change is detected by using a change of the edge. If no scene change occurs, though a position of the present edge and a position of an edge in a prior frame are similar, if there is a scene change, the position of the present edge is different from the position of the edge in the prior frame. In the method of block matching, a block matching in which similar blocks between adjacent frames are searched, for using as a scale for detecting the scene change. At first, an image is divided into a plurality of blocks which do not overlap to another, and a most similar block is searched from a prior frame for each block. A level of difference from the searched most similar block is represented with 0˜1, the values are passed through a non-linear filters, to generate a difference value between frames, and scene change is determined by using the difference value.

However, the foregoing related art scene change detecting methods have the following problems.

The related art scene change detecting methods detects a scene change, not by recognizing contents of each scene, but by observing a change of primitive feature, such as a color or luminance of a pixel. Therefore, the related art scene change detecting method has a disadvantage in that the related art scene change detecting method can not distinguish a progressive change within a scene caused by movements of persons, objects, or camera, from a progressive scene change, such as fade, dissolve, or wipe.

### DISCLOSURE OF INVENTION

An object of the present invention designed to solve the foregoing problems lies on providing a method for detecting a scene change, in which, though a scene change is identified by detecting a change of primitive feature in the present invention too, two stage detection is applied, for accurate and stable detection of any form of scene change.

The object of the present invention is achieved by providing a method for detecting a scene change by sensing change of an image frame feature, including a first step for determining a change between adjacent frames to sort frames into a transition state and a stationary state, and a second step for re-determining a scene change of the sorted frames, and fixing the scene change.

The first step includes an algorithm having the steps of initializing a mode and a stack, decoding the present frame and storing an image in an IS, extracting feature vectors from the image of the present frame and storing in a VS, storing a difference between feature vectors of recent two frames stored in the VS in a DQ, determining if the difference between feature vectors stored in the DQ is adequate for a mode change, determining if the IS and VS are full, and determining if the frame is a final frame.

The second step includes an algorithm having the steps of setting entire frames as one segment if it is in a stationary mode, dividing the frames into a plurality of segments and setting the frames as the plurality of segments if it is in a transition mode, determining existence of segments of respective modes, and determining necessity of division of each segment into independent scenes if the segments exist.

### BRIEF DESCRIPTION OF DRAWINGS

The accompanying drawings, which are included to provide a further understanding of the invention, illustrate embodiments of the invention and together with the description serve to explain the principles of the invention:

In the drawings:

FIG. 1 illustrates a diagram showing an image difference between adjacent frames along a time axis;

FIG. 2 illustrates a flow chart showing the steps of a method for detecting a scene change in accordance with a preferred embodiment of the present invention;

FIG. 3 illustrates a diagram describing a quantum change from YCbCr space to HSV space;

FIG. 4 illustrates a flow chart showing a second stage of FIG. 2;

FIG. 5 describes a method for dividing frames stored in IS, and VS into segments; and

FIG. 6 illustrates a flow chart showing the steps of a method for determining a necessity for dividing each segment into independent scenes.

### BEST MODE FOR CARRYING OUT THE INVENTION

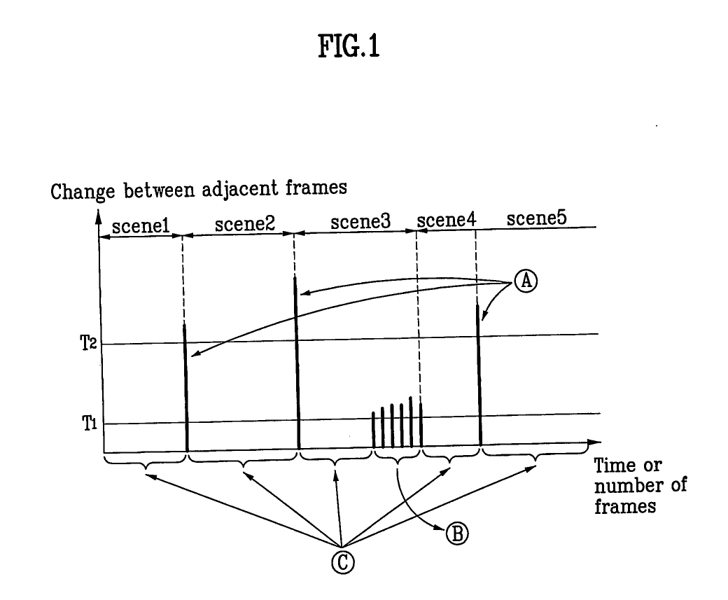

Reference will now be made in detail to the preferred embodiments of the present invention, examples of which are illustrated in the accompanying drawings. In describing the embodiments, same parts will be given the same names and reference symbols, and additional description of which will be omitted. FIG. 1 illustrates a diagram showing an image difference between adjacent frames along a time axis.

Referring to FIG. 1, scenes each having a plurality of frames arranged along a time axis, with the frame in each scene having image feature vectors calculated based on image features, such as colors, and edge intensities, and changes between adjacent frames calculated by using the image feature vectors are illustrated.

The frames in each scene can be sorted as frames with changes between adjacent frames, and frames without changes between adjacent frames, with reference to a difference of image feature vectors. With reference to threshold values T1 and T2 (T1<T2) in the drawing, frames each with a threshold value greater than T2 are frames • having sudden changes, frames each with a threshold value greater than T1 but smaller than T2 are frame having progressive changes •, and frames each with a threshold value smaller than T1 are frames without changes •.

In the method for detecting a scene change of the present invention, there are transition frames and stationary frames. That is, frames with a threshold value greater than T2 are sorted as the transition frames, alike • in FIG. 1, N or more than N consecutive frames each with a threshold value greater than T1 but smaller than T2 are sorted as the transition frames starting from a starting point of the N consecutive frames, and N or more than N consecutive frames each with a threshold value not greater than T1 are sorted as the transition frames up to a starting point of the N consecutive frames, and frames thereafter are sorted as stationary frames.

A first step of the present invention is sorting frames with/without changes between adjacent frames.

Referring to FIG. 1, parts with frames each with a threshold value greater than T2 represent the cuts with sudden scene changes, and parts with N or more than N consecutive frames each with a threshold value not greater than T2 but greater T1 represent the fade, dissolve, or wipe with progressive scene change. That is, the scene change can occur between adjacent frames suddenly, the scene change can also occur progressively over many frames. As shown in FIG. 1, if it is regarded that a new scene starts right after a scene change process is finished completely, one scene may be a bundle of frame starting from a starting point of the stationary state to an end point of the transition state.

A second step of the present invention re-identifies the scene change according to the state change detected in the first step, and unifies a scene having a scene edge detected incorrectly, or a scene determined worth to divide into an individual scene with a prior scene.

For an example, if brightness of a video changes sharply due to lightning or flash, or if a part of image is damaged from transmission error or the like, though there is a sudden change between adjacent frames, to misunderstand as if there is a scene change, it is required to unify the two scenes, because there are the same scenes on both sides of a edge divided thus. Or, in a case of a scene fading out into white or black, though the scene is divided into frames having a progressive change, it is required that scenes after the fading out are unified with prior scene because the scenes after the fading out only have black or white scenes, that are worthless to sort as independent scenes. This correction in the second step permits more accurate scene change detection.

Thus, the method for detecting a scene change of the present invention includes a first step in which frames are sorted with respect to changes between adjacent frames, and a second step in which the scene change of the sorted frames is re-identified and fixed.

Now the present invention will be described in detail, with reference to the drawings.

The first step, an algorithm, includes the steps of initializing a mode and a stack, decoding the present frame and storing an image in an IS, extracting feature vectors from the image of the present frame and storing in a VS, storing a difference between feature vectors of recent two frames stored in the VS in a DQ, determining if the difference between feature vectors stored in the DQ is adequate for a mode change, determining if the IS and VS are full, and determining if the frame is a final frame.

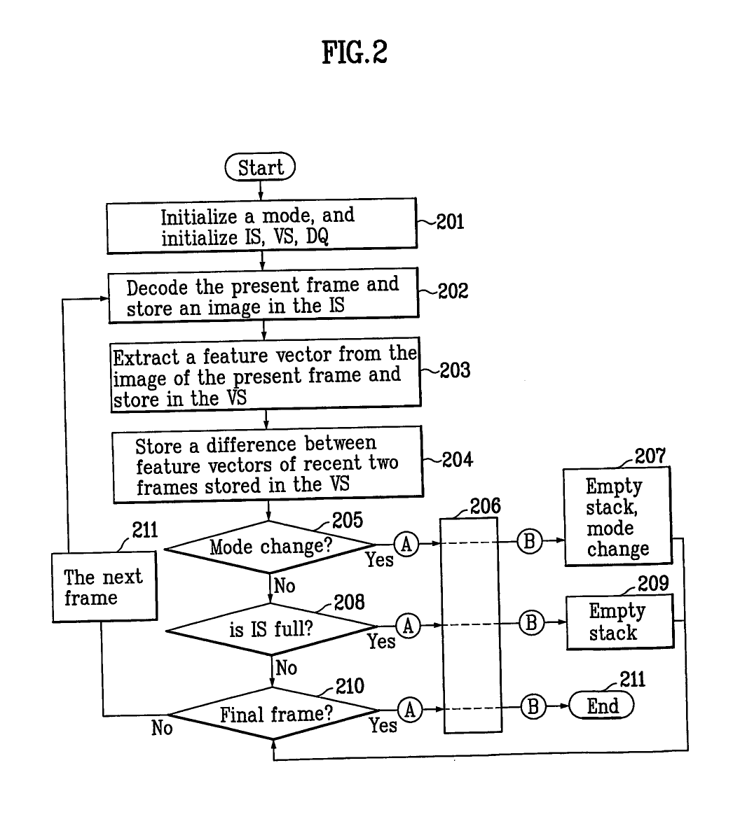

FIG. 2 illustrates a flow chart of the first step.

Referring to FIG. 2, in the initializing step 201, a state parameter mode, representing the present frame of being in a stationary state or in a transition state, is initialized into the stationary mode, and IS, VS, and DQ are initialized. The IS is a stack for storing frame images, and the VS is a stack for storing feature vectors extracted from the frame images. Both the IS and VS can store M number of items, respectively. In the present invention, it is effective to set the ‘M’ of being approx. 180. The DQ, a circular queue for storing a change between adjacent frames, can store N items, where the N=3 is appropriate.

In the foregoing initialized state, a video decoder decodes one frame of video and stores in the IS (202). Since almost all videos are compressed and stored in an YCbCr format, the IS has images stored in the YCbCr format. Then, feature vectors are extracted from the present frame stored in the IS, and stored in the VS (203).

The feature vector has an edge histogram and a color histogram. The edge histogram and the color histogram have complementary image features, wherein the edge histogram mostly represents change of a luminance Y component, and the color histogram mostly represents a change of a color (CbCr) component.

The edge histogram divides a Y component image into ‘W’ number of width direction blocks and H number of height direction blocks, none of which are overlapped, and calculates edge component intensities in four directions (width, height, 45°, and 135°) in each block. Consequently, the edge histogram becomes to have W×H×4 items. For calculating the edge histogram, absolute values between adjacent pixels in the four directions are accumulated, a fast computation of which is possible if an SIMD (Single Instruction Multiple Data) structure, such as an MMX, is used.

In the meantime, the color histogram is carried out in an HSV (Hue Saturation Value) space. Since an YCbCr model is a color model far from human sensing, even though the YCbCr model is very effective in compressing a video data, the histogram is calculated after pixel values of each frame displayed in the YCbCr space are mapped to the HSV space.

A transformation from the YCbCr space to the HSV space can be done with the following equations.

$$\begin{matrix}V = Y , 0 \leq V \leq 255 & ( 1 ) \\ S = \sqrt{( Cr - 128 ) 2 + ( Cb - 128 ) 2 ,} 0 \leq S \leq 128 & ( 2 ) \\ H = {tan}^{- 1} ( Cr - 128 ) / ( Cb - 128 ) \times ( 180 / π ) - 108 , \\ 0 \leq H \leq 360 & ( 3 )\end{matrix}$$

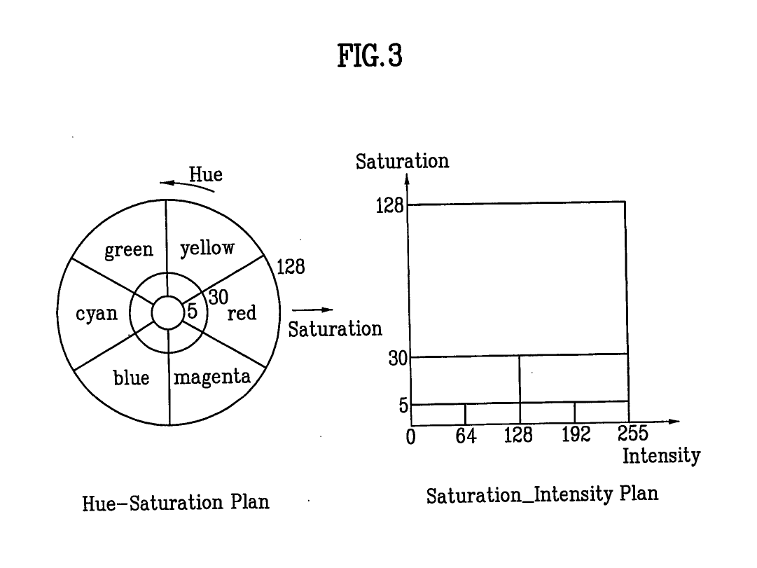

The quantization is carried out by a method illustrated in FIG. 3. That is, hue of a pixel having a saturation equal to, or smaller than 5 is disregarded taking the hue as a gray scale, while an intensity thereof is quantized in four stages each with 64 levels, a color having a saturation greater than 5 but equal to or smaller than 30 is quantized with respect to hue in 6 stages each with 60°, and with respect to intensity in two stages each with 128 levels. Intensity of a color having a saturation greater than 30 is disregarded, while hue thereof is quantized in 6 stages each with 60°. A saturation greater than 30 is quantized coarser than a saturation smaller than 30 for reflecting a fact that a probability of occurrence of great saturation is small in a general video image. Thus, a histogram having 22 items are prepared.

Once the feature vectors are extracted thus, the feature vectors are stored in the VS (203), a difference between frames is calculated by using the feature vector extracted from a prior frame and stored in the VS, and the feature vector extracted from the present frame, and a result of which is stored in the circular queue DQ. The difference between the feature vectors is calculated according to the following equation.
D=WeDe+WcDc (4)

Where, De and Dc denote differences of feature vectors obtained by using the edge histogram and the color histogram respectively, and We and Wc denote constants representing weighted values thereof, respectively.

The De and Dc are calculated by accumulating differences of histograms of the present frame and the prior frame, respectively.
De=Σ∥EHₙ[i]−EHₙ₋₁[i]∥ (5)
Dc=Σ∥CHₙ[i]−CHₙ₋₁[i]∥ (6)

Where, EH[i] and CH[i] respectively denote (i)th items of the edge histogram and the color histogram, and subscripts ‘n’ and ‘n−1’ denote indices representing the present frame and a prior frame.

Once a change between two frames are calculated and stored in the circular queue DQ (204), by using which it is determined whether a value of a state parameter mode is to be changed or not (205). As described, the mode is a state parameter representing the present frame of being in a stationary state or in a transition state.

Mode change conditions are as follows.

When the present mode is the stationary mode, it is required to change the mode to the transition mode if the most recent value stored in the DQ is greater than the threshold value T2, or recent N values are greater than T1.

Opposite to this, when the present mode is the transition mode, it is required to change the mode into the stationary mode if all values of recent N items stored in the DQ are smaller than the threshold value T1.

Every moment the mode is changed, the second step 206 of verification is made, which will be described later.

After the second step (207) is passed, the IS and the VS are emptied, and the value of the state parameter mode is changed. In this instance, it is required to pay attention to a point that, in a case the change is from the stationary state to the transition state, though all values stored in the IS and the VS are erased, to start newly, in a case the change is from the transition state to the stationary state, it is required that recent N items in the stack IS and VS are not erased, but remained.

This is because the mode change can be known after N frames are passed from a time the change from the transition state to the stationary state is made, since the change from the transition state to the stationary state requires that recent N frames have no change between adjacent frames. Consequently, it is required that an operation in the next stationary state is started after going back N frames. Therefore, not by erasing, but by remaining the recent N items in the stack, the same effect can be obtained.

When there is no change of the mode (205), the present mode is kept, while verifying if the stack is full (208) because the image and feature vector are stored in the stack for every frame. Both the IS and the VS are stacks each of which can store M limited items, that limits a maximum length of a scene which can be processed at a time. If one scene proceeds longer than this without mode change, the stack becomes full, then, the process proceeds to the second step.

In general, even in a case when there are almost no changes between frames in a scene, it is required to give confirmation of division of the scene at fixed intervals, because a substantial change can be made if very slow movements of a camera, or a person or an object in the scene are accumulated for a long time. Sizes of the IS and VS are very these time intervals, and a step for giving confirmation whether the scene is divided or not at this time is taken, if the stack is full beyond this time interval. In this instance too, when the second step is finished, the stack is emptied for processing the next scene (209). In this case, the stack is emptied fully, regardless of the mode.

When all the forgoing processes are finished, it is determined if the present frame is a final frame (210). If the present frame is not the final frame, the next frame is decoded, and progresses the process (211), and if yes, a final scene is processed. The final scene processing is repetition of the second step (206), when it is determined whether a series of frames remained at an end part of the video is processed as an independent scene or not, even if no mode change is made. After the final frame is processed, entire operation ends (212).

FIG. 4 illustrates a flow chart of the second step.

The second step, an algorithm applicable to a case when a difference between feature vectors stored in the DQ meets mode change conditions, a case when the IS, and VS are full, or a case the frame is the final one, includes the steps of setting entire stored frames as one segment if it is in a stationary mode, dividing the frames into a plurality of segments and setting the frames as the plurality of segments if it is in a transition mode, determining existence of segments of respective modes, and determining necessity of division of each segment into independent scenes if the segments exist.

Referring to FIG. 4, according to the state parameter mode (401), all the frames stored in stack IS and VS are processed, with all the frames taken as one segment (402) if it is in a stationary state, and all the frames stored in stack IS and VS are processed, with all the frames divided into segments (403), if it is in a transition state.

The division into segments is made as follows.

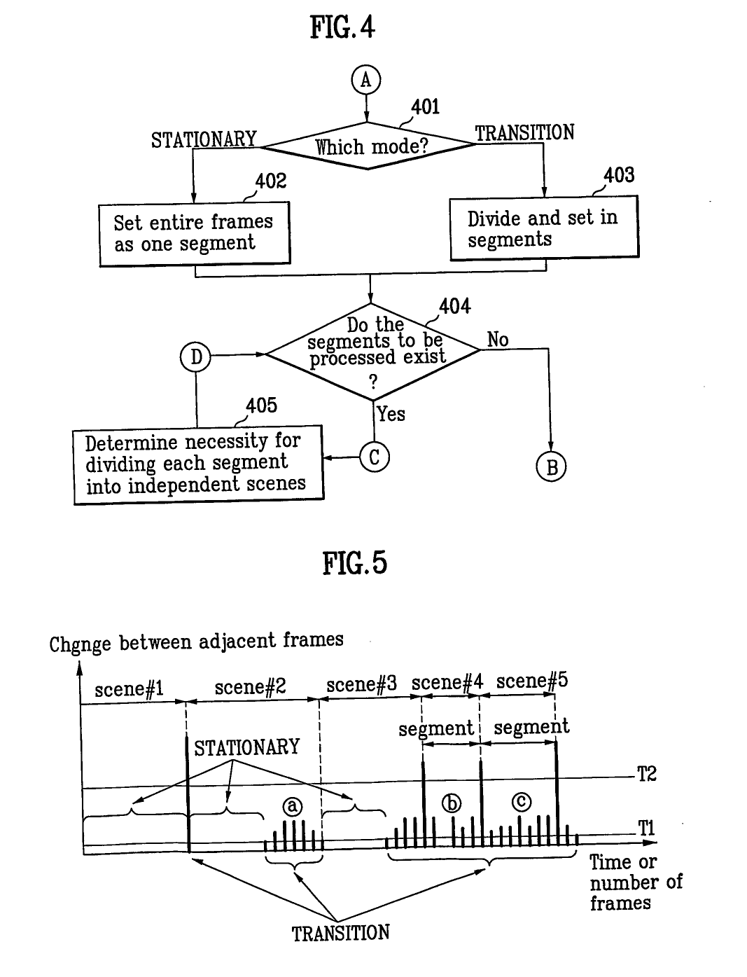

Referring to FIG. 5, it is preferable that frames in a transition state like • in FIG. 5 unify with frames in a stationary state into one scene, frames having sudden changes over the threshold value T2 like \textcircled{b} and \textcircled{c} in FIG. 5 are separated into individual scenes. Accordingly, the frames in a transition state are dealt, separating the frames with reference to the frame having a threshold value greater than T2. That is, of the frames in a transition state, if there are K frames each having a threshold value greater than T2, and K−1 segments, it is determined if it is necessary to separate each of the segments into independent scenes (405).

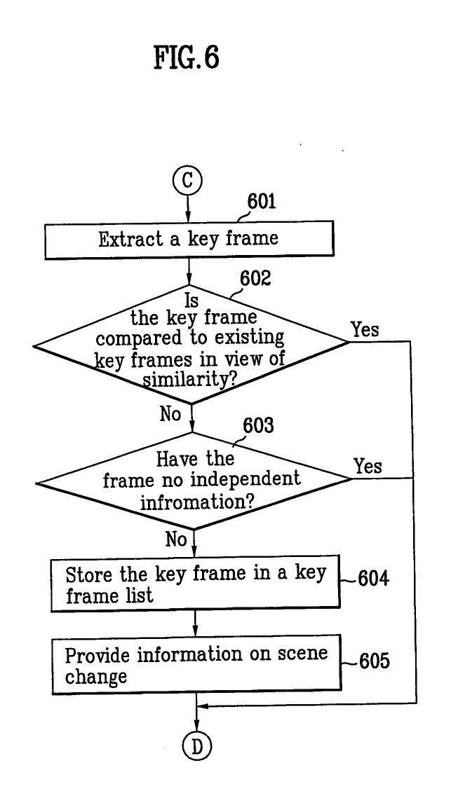

FIG. 6 illustrates a flow chart of this operation.

In a case there are such segments, the step for determining the necessity of dividing each segment into independent scene, an algorithm, includes the steps of extracting a key frame, determining if the key frame is identical to an already stored frame, determining if the key frame has information if not identical, storing the key frame in a key frame list if the key frame has information, and providing scene change information with reference to the information on the stored key frame list.

Referring to FIG. 1, for carrying out this operation, the key frame list is used. The key frame list is a memory space for storing an image of a frame representing a scene that is sensed as an independent scene, and the feature vector extracted from the image. At first, a middle frame of the present segments is selected as the key frame (601). If there are items stored in the key frame list, recent L key frames and the key frame extracted from the present frame are compared, and it is determined that the present segment is similar to the scene detected recently (602). Similarity with recent L key frames is examined because of the following reasons.

First, there are cases when the scene is divided, even if the scene is one in view of content owing to momentary great difference between frames caused by a sudden change of illumination, or pass of a fast object across the image. By examining similarity with a scene detected previously, wrong division of the scene can be corrected. Second, in a case a camera takes two or three persons alternately, in which the same scene is repeated once in every 2˜3 scenes, such an unnecessary division of repetitive scenes can be corrected by examining similarity with adjacent 2˜3 scenes.

In order to determine similarity with the recent L key frames, a method of determining similarity of images by using feature vectors extracted from key frames and a method of calculating a correlation coefficient between the key frame images and examining if the correlation coefficient is greater than a specific threshold value, are used in parallel.

If the key frame of the present segment has no similarity with the L key frames detected recently, it is determined that if the segment has adequate information enough to be separated as an independent scene (603). To do this, a variance of the present key frame is calculated, and determined if the variance is greater than a specific threshold value. If the variance of the present key frame is not greater than the specific threshold value, the scene is not divided, because the case the variance of the present key frame is not greater than the specific threshold value falls on a case when the image is in a black or white state due to a scene change effect of fade out or the like, or the segment is meaningless in which no particular information can be obtained even if the segment is divided into an independent scene.

Since a segment passed through all the foregoing verification is qualified to be sensed as an independent scene, a key frame and a feature vector extracted from the present segment are stored in the key frame list (604), and scene change information, such as a starting of the segment and the like are provided (605).

### INDUSTRIAL APPLICABILITY

As has been described, the method for detecting a scene change of the present invention permits an accurate detection of the scene change of any form, at a fast speed equal to approx. 4% of a speed of video play in which no scene change is carried out.

What is claimed is:

1. A method for detecting a scene change by sensing change of an image frame feature, comprising:
a first step for determining a change between adjacent frames to sort frames into a transition state and a stationary state; and
a second step for re-determining a scene change of the sorted frames, and fixing the scene change.

2. The method as claimed in claim 1, wherein the first step includes an algorithm having the steps of;
initializing a mode and a stack,
decoding the present frame and storing an image in an IS,
extracting feature vectors from the image of the present frame and storing in a VS,
storing a difference between feature vectors of recent two frames stored in the VS in a DQ,
determining if the difference between feature vectors stored in the DQ is adequate for a mode change,
determining if the IS and VS are full, and
determining if the frame is a final frame.

3. The method as claimed in claim 1, wherein the second step includes an algorithm having the steps of;
setting entire frames as one segment if it is in a stationary mode,
dividing the frames into a plurality of segments and setting the frames as the plurality of segments if it is in a transition mode,
determining existence of segments of respective modes, and
determining necessity of division of each segment into independent scenes if the segments exist.

4. The method as claimed in claim 2, wherein the first step proceeds to the second step in a case a difference between feature vectors stored in the DQ meets mode change conditions, a case the IS, and VS are full, or a case the frame is the final one.

5. The method as claimed in claim 4, wherein the step of determining necessity of division of each segment into independent scenes if segments which can be processed exist includes the steps of;
extracting a key frame from each segment,
determining if the key frame is identical to an already stored frame,
determining if the key frame has information if not identical,
storing the key frame in a key frame list if the key frame has information, and
providing scene change information with reference to the information on the stored key frame list.

6. The method as claimed in claim 4, wherein, in a case the step of determining existence of segments to be processed is passed in the second step as the difference of feature vectors stored in the DQ is adequate for a mode change, if the segments do not exist, the IS and VS are emptied, and the mode is changed.

7. The method as claimed in claim 6, wherein, in a case the change is made from the transition mode to the stationary mode, a predetermined number of items stored in the IS and VS recently are not erased.

8. The method as claimed in claim 4, wherein, in a case the step of determining existence of the segments to be processed is passed in the second step as the IS and VS are full, the IS and VS are emptied if the segments do not exist.

9. The method as claimed in claim 4, wherein, in a case the step of determining existence of the segments to be processed is passed in the second step as the frame to be processed is a final frame, the algorithm of the method for detecting a scene change of the present invention ends if the segments do not exist.

10. The method as claimed in claim 1, wherein, differences between adjacent frames are sorted along a time axis by applying threshold values T1 and T2 (T1<T2).

11. The method as claimed in claim 10, wherein, frames with a threshold value greater than T2 are sorted as the transition frames, N or more than N consecutive frames each with a threshold value greater than T1 but smaller than T2 are sorted as the transition frames starting from a starting point of the N consecutive frames, and N or more than N consecutive frames each with a threshold value not greater than T1 are sorted as the transition frames up to a starting point of the N consecutive frames, and frames thereafter are sorted as stationary frames.

12. The method as claimed in claim 2, wherein the IS and VS store predetermined numbers of items.

13. The method as claimed in claim 12, wherein the predetermined number is approx. 180.

14. The method as claimed in claim 2, wherein the DQ stores a predetermined number of items.

15. The method as claimed in claim 14, wherein the predetermined number is approx. 3.
